(19) United States
(12) Patent Application Publication
(10) Pub. No.: US 2021/0334734 A1
(43) Pub. Date: Oct. 28, 2021

(54) METHOD AND SYSTEM FOR PRESENTING DIGITAL TASK IMPLEMENTED IN COMPUTER-IMPLEMENTED CROWD-SOURCED ENVIRONMENT

(71) Applicant: YANDEX EUROPE AG, Luzem (CH)

(72) Inventors: Alexey Valerevich DRUTSA, Moscow (RU); Anna Valerevna LIOZNOVA, Sankt-Peterburg (RU); Vitaly Dmitrievich POLSHKOV, Sankt-Peterburg (RU)

(21) Appl. No.: 17/239,467

(22) Filed: Apr. 23, 2021

(30) Foreign Application Priority Data
Apr. 23, 2020 (RU) 2020114574

(51) Int. Cl. G06Q 10/06; G06N 20/00; G06Q 10/10

(52) U.S. Cl. CPC G06Q 10/063114; G06Q 10/101; G06Q 10/06316; G06N 20/00

(57) ABSTRACT

There is disclosed a method and system for presenting a digital task in a computer-implemented crowd-sourced environment. The method comprises: receiving from an electronic device an indication of a desire to complete one or more digital tasks; generating a subset of digital tasks from the plurality of digital tasks; for each of the subset of digital tasks, determining an exposure parameter; generating a ranked list of the subset of digital tasks, the generating including: generating a first ranked list of the subset of digital tasks; based on the exposure parameter of the given one of the subset of digital tasks not meeting a pre-determined threshold, promoting a rank of the given one of the subset of digital tasks to generate a final ranked list; transmitting the final ranked list to the electronic device for displaying.

### CROSS-REFERENCE

The present application claims priority to Russian Patent Application No. 2020114574, entitled “Method and System for Presenting Digital Task Implemented in Computer-Implemented Crowd-Sourced Environment”, filed Apr. 23, 2020, the entirety of which is incorporated herein by reference.

### FIELD

The present technology relates to methods and systems for presenting a digital task, and more particularly methods and systems for presenting a digital task in a computer-implemented crowd-sourced environment.

### BACKGROUND

Machine learning algorithms require a large amount of labelled data for training. Crowd-sourced platforms, such as the Amazon Mechanical Turk™, make it possible to obtain large data sets of labels in a shorter time, as well as at a lower cost, compared to that needed for a limited number of experts.

Typically, assessors available on the crowd-sourced are non-professional and vary in levels of expertise. Moreover, assessors are typically motivated to perform tasks for which the assessor is more knowledgeable or experienced. For example, a worker may be good at labelling images, and as such would rather select image labelling tasks rather than image-to-text (“CAPTCHA”) tasks for both economic and/or time efficiency reasons.

The preference of the assessors toward experienced and/or well-paid tasks result, in some instances, in a concentrated exposure and selection of only a subset of available tasks. For example, assessors may only look and select the top-ranked tasks similar to a human's behavior when executing a search on a search engine.

Needless to say, such over-exposure of the subset of available tasks prevents a large proportion of other available tasks to be disregarded due to the limited exposure to the assessors.

European Patent Application Publication No. 3438897 A1 published Feb. 6, 2019, to Swisscom Schweiz AG and titled “Task Allocator for Crowd Sourcing Network”, discloses a task allocator provided for: (i) determining which open tasks to allocate on a crowd sourcing network, and (ii) allocating said tasks to users of the crowd sourcing network. The task allocator includes a processor and a data store, and is configured to determine which tasks to allocate to users of the crowd sourcing network based on indications of previous tasks stored in the data store. The data store is updated dynamically in response to new tasks being finished. Based on the contents of the dynamically updated data store, the task allocator may adaptively allocate tasks to a user. The task allocator determines which tasks to allocate based on a plurality of determined metrics, which are determined based on the contents of the data store.

U.S. Pat. No. 9,911,088 B2 issued Mar. 6, 2018 to Microsoft Technology Licensing LLC, and titled “Optimizing Task Recommendations in Context-Aware Mobile Crowdsourcing”, discloses various processes to optimize task recommendations for workers in mobile crowdsourcing scenarios by automatically identifying and recommending bundles of tasks compatible with workers' contexts (e.g., worker history, present or expected locations, travel paths, working hours, skill sets, capabilities of worker's mobile computing devices, etc.). The Context-Aware Crowdsourced Task Optimizer bundles tasks to both maximize expected numbers of completed tasks and to dynamically price tasks to maximize the system's utility, which is a function of task values and task completion rates. Advantageously, the resulting task identification and recommendation process incentivizes individual workers to perform more tasks in a shorter time period, thereby helping tasks to complete faster, even with smaller budgets. While such optimization problems are NP-hard, the Context-Aware Crowdsourced Task Optimizer exploits monotonicity and submodularity of various objective functions to provide computationally feasible task identification and recommendation algorithms with tight optimality bounds.

### SUMMARY

Non-limiting embodiments of the present technology have been developed based on developers' appreciation of at least one technical problem associated with the prior art solutions.

In developing the present technology, developers of the present technology have realized that it may be desirable to better balance exposure of various digital tasks in the computer-implemented crowd-sourced environment. More specifically, the developers of the present technology have realized that there are certain digital tasks that are associated with a comparatively high return for the crowd-sourced workers and a comparatively low difficulty, but yet receive a comparatively low exposure to the crowd-sourced workers. This comparatively low exposure to the crowd-sourced workers can in turn translate into such digital tasks not being picked for execution by the crowd-sourced workers. Developers of the non-limiting embodiments of the present technology deem such comparatively low exposure to be abnormal, in a sense, that these digital tasks should be receiving a higher exposure (based on the return and the difficulty level), but they do not.

Indeed, taking a look at FIG. 7, there is illustrated a graph of a typical normal distribution of exposure (y-axis) for a set of tasks (x-axis). Normally, the distribution of the exposure should be in an inverse proportional relationship with a task parameter (such as the revenue, the quality, the estimated time of completion, etc.) of the tasks. In the illustrated example, the tasks may be sort in a descending order based on the revenue or increased order based on the difficulty per task. As illustrated, the more high-paid (or easiest) the task is, there is a higher incentive for the crowd-sourced workers to complete.

A non-limiting example of an abnormal distribution would correspond to a situation where the relationship between the exposure and the task parameter does not follow a linear relationship. For example, if a given task that is easier (and/or better paid) than another task, yet it receives less exposure than the other task.

Hence, developers of the present technology have developed methods and systems for selecting digital tasks in the computer-implemented crowd-sourced environment and, more specifically, a method for calculating a parameter indicative of how exposed each task within the computer-implemented crowd-sourced environment is. By determining such parameter, it is possible to select digital tasks to be displayed to the assessor. In other words, methods and systems disclosed herein make it possible for under-exposed tasks to be displayed more frequently to the crowd-sourced workers.

According to a first broad aspect of the present technology, there is disclosed a computer-implemented method for presenting a digital task in a computer-implemented crowd-sourced environment, the computer implemented environment being associated with a plurality of digital tasks to be executed by one or more of a plurality of crowd-sourced workers, the plurality of digital tasks including the digital task, the method being executed by a server, the method comprising: receiving, by the server, from an electronic device associated with a given crowd-sourced worker an indication of a desire to complete one or more digital tasks; generating, by the server, a subset of digital tasks from the plurality of digital tasks, for presentation on the electronic device; for each of the subset of digital tasks, determining, by a server, an exposure parameter, the exposure parameter being indicative of a number of crowd-sourced workers a given one of the subset of digital tasks has been exposed to; generating, by the server, a ranked list of the subset of digital tasks, the generating including: generating a first ranked list of the subset of digital tasks; based on the exposure parameter of the given one of the subset of digital tasks not meeting a pre-determined threshold, promoting a rank of the given one of the subset of digital tasks to generate a final ranked list, where the rank of the given one of the subset of digital tasks is higher than in the first ranked list; transmitting, by the server, the final ranked list to the electronic device for displaying thereon; receiving, by the server, a crowd-sourced worker response to at least one of the digital tasks in the final ranked list.

In some non-limiting embodiments of the method, the generating the subset of digital tasks comprises receiving, by the server, a filter request from the electronic device, and wherein the generating the subset of digital tasks comprises selecting the subset of digital tasks based on the filter request.

In some non-limiting embodiments of the method, the exposure parameter is based on a pre-determined exposure event.

In some non-limiting embodiments of the method, the pre-determined exposure event is at least one of: a screen-showing event to any one of the plurality of crowd-sourced workers, a click event, and a task completion event.

In some non-limiting embodiments of the method, the method further comprises updating the exposure parameter for the given one of the subset of digital tasks based on the crowd-sourced worker response.

In some non-limiting embodiments of the method, the method further comprises updating the exposure parameter for other digital tasks of the subset of digital tasks based on the crowd-sourced worker response.

In some non-limiting embodiments of the method, the exposure parameter is based on two or more pre-determined exposure events.

In some non-limiting embodiments of the method, the two or more pre-determined exposure events are weighted.

In some non-limiting embodiments of the method, the pre-determined threshold is a normal distribution of exposure parameters in a normally distributed subset of the plurality of digital tasks.

In some non-limiting embodiments of the method, the pre-determined threshold is a value indicative of desired past exposure events and a total exposure volume including past exposure events and desired future exposure events.

In some non-limiting embodiments of the method, the promoting the rank of the given one of the subset of digital tasks is further based on a crowd-sourced worker preference parameter.

In some non-limiting embodiments of the method, the promoting is based on optimizing one or both of the exposure parameter and the crowd-sourced worker preference parameter.

In some non-limiting embodiments of the method, the optimizing is executed by a Machine Learning Algorithm (MLA).

In some non-limiting embodiments of the method, the generating the first ranked list comprises generating randomly generated ranks.

In some non-limiting embodiments of the method, the generating the first ranked list comprises generating a rank based on preferences of the given crowd-sourced worker.

In accordance with another broad aspect of the present technology, there is disclosed a system for presenting a digital task in a computer-implemented crowd-sourced environment, the computer implemented environment being associated with a plurality of digital tasks to be executed by one or more of a plurality of crowd-sourced workers, the plurality of digital tasks including the digital task, the system comprising a server, the server comprising a processor configured to: receive from an electronic device associated with a given crowd-sourced worker an indication of a desire to complete one or more digital tasks; generate a subset of digital tasks from the plurality of digital tasks, for presentation on the electronic device; for each of the subset of digital tasks, determine, an exposure parameter, the exposure parameter being indicative of a number of crowd-sourced workers a given one of the subset of digital tasks has been exposed to; generate, a ranked list of the subset of digital tasks, the generating including: generating a first ranked list of the subset of digital tasks; based on the exposure parameter of the given one of the subset of digital tasks not meeting a pre-determined threshold, promoting a rank of the given one of the subset of digital tasks to generate a final ranked list, where the rank of the given one of the subset of digital tasks is higher than in the first ranked list; transmit, the final ranked list to the electronic device for displaying thereon; receive, a crowd-sourced worker response to at least one of the digital tasks in the final ranked list.

In some non-limiting embodiments of the system, to generate the subset of digital tasks, the processor is configured to receive a filter request from the electronic device, and wherein the generating the subset of digital tasks comprises selecting the subset of digital tasks based on the filter request.

In some non-limiting embodiments of the system, the exposure parameter is based on a pre-determined exposure event.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations, etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a system implemented in accordance with non-limiting embodiments of the present technology.

FIG. 2 depicts a screen shot of a crowd-sourced platform interface implemented in accordance with a non-limiting embodiment of the present technology. The crowd-sourced platform interface is being depicted as displayed on a screen of an electronic deice of the system, of FIG. 1.

FIG. 3 depicts a schematic illustration of a set of exposure events.

FIG. 4 depicts a schematic diagram of a process for presenting a digital task in a crowd-sourced environment.

FIG. 5 depicts a schematic illustration of a graph illustrating an actual exposure parameters distribution.

FIG. 6 depicts a block diagram of a flow chart of a method for presenting a digital task in a computer-implemented crowd-sourced environment.

FIG. 7 depicts a schematic illustration of a graph illustrating a normal exposure parameters distribution.

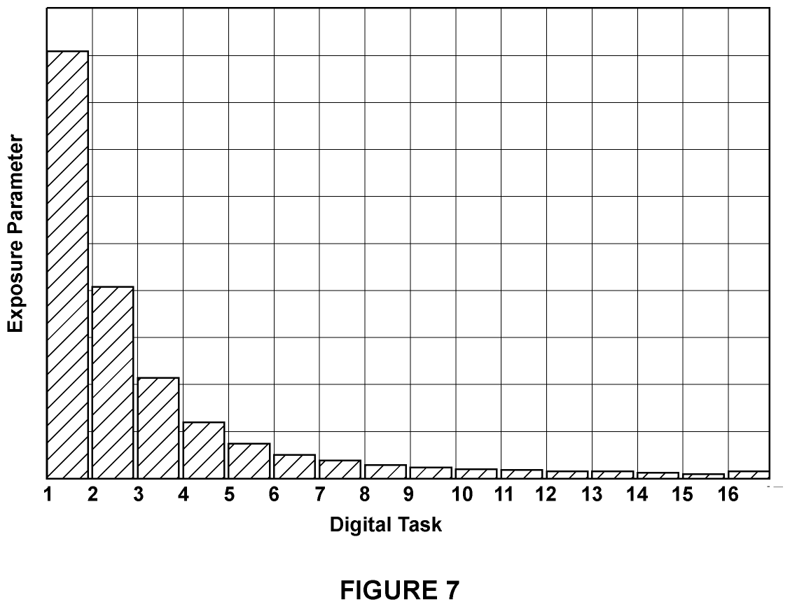

### DETAILED DESCRIPTION

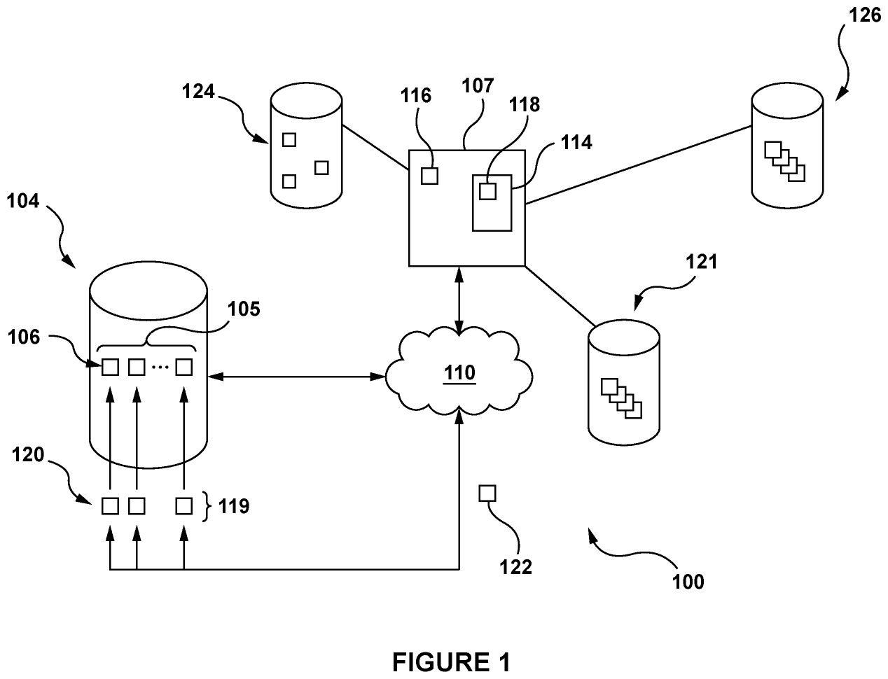

Referring to FIG. 1, there is shown a schematic diagram of a system 100, the system 100 being suitable for implementing non-limiting embodiments of the present technology. Thus, the system 100 is an example of a computer-implemented crowd-sourced environment. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

The system 100 comprises a server 102 and a database 104 accessible by the server 102.

As schematically shown in FIG. 1, the database 104 comprises an indication of identities of a plurality of crowd-sourced workers 105 (which includes a crowd-sourced worker 106), who have indicated their availability for completing at least one type of a crowd-sourced digital task and/or who have completed at least one crowd-sourced task in the past and/or registered for completing at least one type of the crowd-sourced task.

In some non-limiting embodiments of the present technology, the database 104 is under control and/or management of a provider of crowd-sourced services, such as Yandex LLC of Lev Tolstoy Street, No. 16, Moscow, 119021, Russia. In alternative non-limiting embodiments of the present technology, the database 104 can be operated by a different entity.

The implementation of the database 104 is not particularly limited and, as such, the database 104 could be implemented using any suitable known technology, as long as the functionality described in this specification is provided for. In accordance with the non-limiting embodiments of the present technology, the database 104 comprises (or has access to) a communication interface (not depicted), for enabling two-way communication with a communication network 110.

In some non-limiting embodiments of the present technology, the communication network 110 can be implemented as the Internet. In other non-limiting embodiments of the present technology, the communication network 110 can be implemented differently, such as any wide-area communication network, local area communications network, a private communications network and the like.

It is contemplated that the database 104 can be stored at least in part by the server 102 and/or be managed at least in part by the server 102. In accordance with the non-limiting embodiments of the present technology, the database 104 comprises sufficient information associated with the identity of at least some of the plurality of crowd-sourced workers 105 to allow an entity that has access to the database 104, such as the server 102, to assign and transmit one or more tasks to be completed by the plurality of crowd-sourced workers 105.

At any given time, the plurality of crowd-sourced workers 105 may comprise a different number of crowd-sourced workers 105, such as fifty crowd-sourced workers 105, who are available to complete tasks. The plurality of crowd-sourced workers 105 could include more or fewer crowd-sourced workers 105.

The server 102 can be implemented as a conventional computer server. In an example of a non-limiting embodiment of the present technology, the server 102 can be implemented as a Dell™ PowerEdge™ Server running the Microsoft™ Windows Server™ operating system. Needless to say, the server 102 can be implemented in any other suitable hardware and/or software and/or firmware or a combination thereof. In the depicted non-limiting embodiment of the present technology, the server 102 is a single server. In alternative non-limiting embodiments of the present technology, the functionality of the server 102 may be distributed and may be implemented via multiple servers.

The server 102 comprises a communication interface (not depicted) for enabling two-way communication with the communication network 110 via a communication link 108.

How the communication link 108 is implemented is not particularly limited and depends on how the server 102 is implemented. For example, the communication link 108 can be implemented as a wireless communication link (such as, but not limited to, a 3G communications network link, a 4G communications network link, a Wireless Fidelity, or WiFi®, for short, Bluetooth®, or the like) or as a wired communication link (such as an Ethernet based connection).

It should be expressly understood that implementations of the server 102, the communication link 108 and the communication network 110 are provided for illustration purposes only. As such, those skilled in the art will easily appreciate other specific implementational details for the server 102, the communication link 108, and the communication network 110. As such, by no means the examples provided hereinabove are meant to limit the scope of the present technology.

The server 102 comprises a server memory 114, which comprises one or more storage media and generally stores computer-executable program instructions executable by a server processor 116. By way of example, the server memory 114 may be implemented as a tangible computer-readable storage medium including Read-Only Memory (ROM) and/or Random-Access Memory (RAM). The server memory 114 may also include one or more fixed storage devices in the form of, by way of example, hard disk drives (HDDs), solid-state drives (SSDs), and flash-memory cards.

In some non-limiting embodiments of the present technology, the server 102 can be operated by the same entity that operates the database 104. In alternative non-limiting embodiments of the present technology, the server 102 can be operated by an entity different from the one that operates the database 104.

In some non-limiting embodiments of the present technology, the server 102 is configured to execute a crowd-sourcing application 118. For example, the crowd-sourcing application 118 may be implemented as a crowd-sourcing platform such as Yandex.Toloka™ crowd-sourcing platform, or other proprietary or commercial crowd-sourcing platform.

To that end, the server 102 is communicatively coupled to a task database 121. In alternative non-limiting embodiments, the task database 121 may be communicatively coupled to the server 102 via the communication network 110. Although the task database 121 is illustrated schematically herein as a single entity, it is contemplated that the task database 121 may be configured in a distributed manner.

The task database 121 is populated with a plurality of tasks (not separately numbered), each task corresponding to a human intelligence task (also referred herein as HITs, “digital task” or simply “tasks”) (not separately numbered). Generally speaking, each task comprises a plurality of sub-tasks.

How the task database 121 is populated with the plurality of tasks is not limited. Generally speaking, one or more task requesters (not shown) may submit one or more tasks to be stored in the task database 121. In some non-limiting embodiments of the present technology, the one or more task requesters may specify the type of assessors the task is destined to, and/or an estimated revenue for completing the task, a difficulty level of the task as well as an estimated time of completion.

How the task is implemented is not limited. In some non-limiting embodiments of the present technology, the task database 121 includes tasks that may be comparison tasks, CAPTCHA input tasks, nudity recognition tasks, ranking tasks, translation tasks and the like.

Returning to FIG. 1, in accordance with the non-limiting embodiments of the present technology, the crowd-sourcing application 118 is configured to present a subset of tasks to the crowd-sourced worker 106 that has indicated his or her availability. In some non-limiting embodiments of the present technology, the subset of tasks has been selected by the crowd-sourcing application 118 following the crowd-sourced worker 106 providing its preference for the type of tasks he or she wishes to complete. For example, if the crowd-sourced worker 106 has selected a preference for comparison tasks, the subset of tasks comprises only comparison tasks.

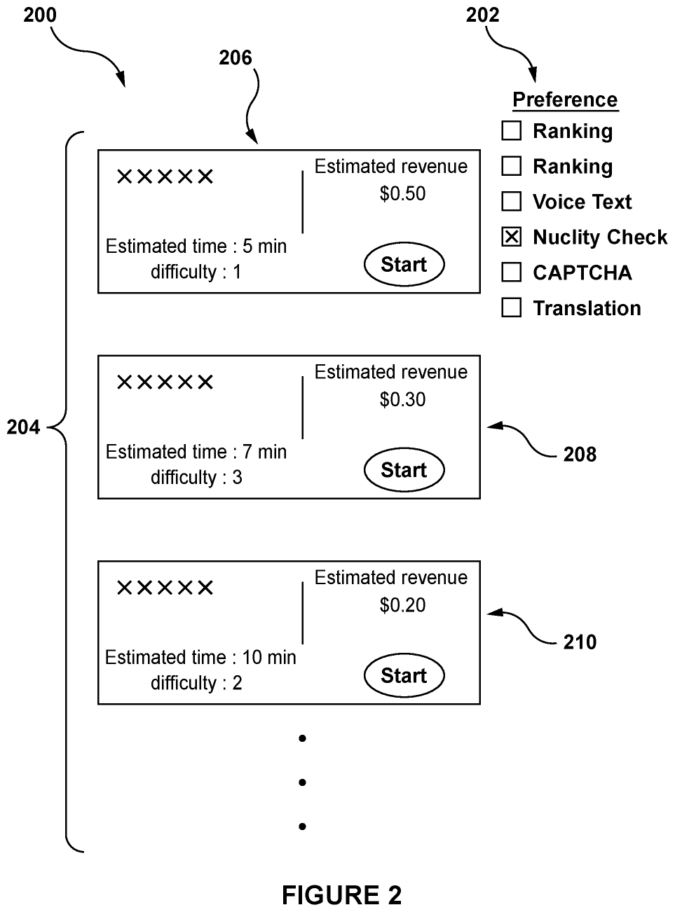

With reference to FIG. 2, there is depicted a screen shot of a crowd-sourced platform interface 200 implemented in accordance with a non-limiting embodiment of the present technology (the example of the interface 200 depicted as displayed on the screen of one of the electronic devices 119). The interface 200 illustrates a task-selection page following the crowd-sourced worker 106 selecting its preference using filters 202.

Let us assume that the crowd-sourced worker 106 has selected image content labelling tasks (such as nudity recognition tasks) as its preference. For example, a nudity recognition task comprises the crowd-sourced worker 106 to be provided with a set of images and select those that contain nudity or pornographic content.

In response to the crowd-sourced worker 106 selecting its preference, the interface 200 displays a subset of tasks 204 on the electronic device 120 associated with the crowd-sourced worker 106 that meets the users provisioned preference. The subset of tasks 204 includes a first task 206, a second task 208 and a third task 210, all of them being a nudity recognition task. For the avoidance of any doubt, it should be understood that the subset of tasks 204 may include more or fewer than three tasks.

Taking a look at the first task 206, the first task 206 is a task that pays $0.50 upon completion. In some non-limiting embodiments of the present technology, the first task 206 also provides an indication of a difficulty level for completing the task as well as an estimated time for completing the task. For the avoidance of any doubt, it should be mentioned that text (and more specifically each letter) included within the interface 200 is represented by “X”, however, in reality the text is made up of words in a given language (such as English). For example, the first task 206 may comprise a title of the task.

The crowd-sourced worker 106 may select one of the first task 206, the second task 208, and the third task 210 to initiate the task.

Returning to FIG. 1, the server 102 is configured to communicate with various entities via the communication network 110. Examples of the various entities include the database 104, the plurality of electronic devices 119 of the plurality of crowd-sourced workers 105, and other devices that may be coupled to the communication network 110. Accordingly, the crowd-sourcing application 118 is configured to retrieve the given task from the task database 121 and send the given task to a respective electronic device 119 used by the plurality of crowd-sourced workers 105 to complete the given task, via the communication network 110 for example.

It is contemplated that any suitable file transfer technology and/or medium could be used for this purpose. It is also contemplated that the task could be submitted to the plurality of crowd-sourced workers 105 via any other suitable method, such as by making the task remotely available to the plurality of crowd-sourced workers 105.

In some non-limiting embodiments of the present technology, the server 102 is further communicatively coupled to an event database 124 via a dedicated link (not numbered). In alternative non-limiting embodiments of the present technology, the event database 124 may be communicatively coupled to the server 102 via the communication network 110, without departing from the teachings of the present technology. Although the event database 124 is illustrated schematically herein as a single entity, it is contemplated that the event database 124 may be configured in a distributed manner.

In some non-limiting embodiments of the present technology, the event database 124 is configured to store a set of exposure events (not separately numbered) associated with each task stored within the task database 121. In the context of the present specification, the phrase “exposure event” may correspond to any event associated with a given task's previous exposure to the plurality of crowd-sourced workers 105.

For example, the set of exposure events may comprise one or more pre-determined exposure events associated with the task. Taking a given task as an example, the exposure events include, but not limited to:
A number of times the given task has been displayed to any one of the plurality of crowd-sourced workers 105 (i.e. a screen-showing);
A number of times the given task has been clicked by any one of the plurality of crowd-sourced workers 105 (a “click event”);
A number of times (or a total duration thereof) the given task has been hovered over by any one of the plurality of crowd-sourced workers 105; and
A number of times the given task has been completed by any one of the plurality of crowd-sourced workers 105.

In some non-limiting embodiments of the present technology the pre-determined exposure events are monitored and recorded from the time the given task has been stored within the task database 121. Alternatively, it is contemplated that the pre-determined exposure events are calculated for a predetermined period of time (such as the past 24 hours, the past week, etc.).

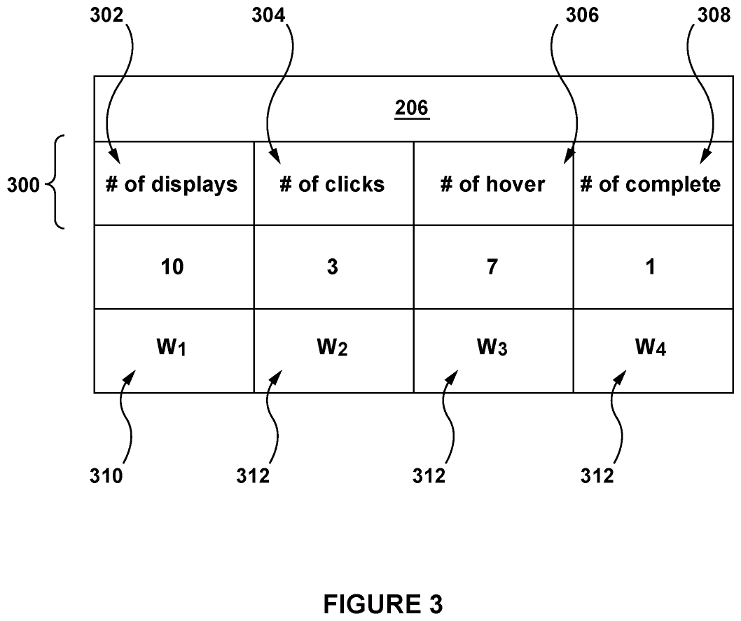

With reference to FIG. 3, there is provided a schematic illustration of the set of exposure events 300 associated with the first task 206 (see FIG. 2).

The set of exposure events 300 comprises a first exposure event 302, a second exposure event 304, a third exposure event 306 and a fourth exposure event 308. For example, the first exposure event 302 may correspond to the number of the time the first task 206 has been displayed to any one of the plurality of crowd-sourced workers 105, the second exposure event 304 may correspond to the number of the time the first task 206 has been clicked by any one of the plurality of crowd-sourced workers 105, the third exposure event 306 may correspond to the number of time (or duration thereof, in seconds, for example) the first task 206 has been hovered by any one of the plurality of crowd-sourced workers 105, and the fourth exposure event 308 may correspond to the number of time the first task 206 has been completed by any one of the plurality of crowd-sourced workers 105.

Let us assume that the first exposure event 302 is indicative that the first task 206 has been displayed 10 times in the past, the second exposure event 304 is indicative that the first task 206 has been clicked 3 times in the past, the third exposure event 306 is indicative that the first task has been hovered 7 times in the past, and the fourth exposure event 308 is indicative that the first task 206 has been completed once in the past.

In some non-limiting embodiments of the present technology, a weighted parameter is calculated for each of the first exposure event 302, the second exposure event 304, the third exposure event 306 and the fourth exposure event 308.

More specifically, a coefficient is multiplied by each the first exposure event 302, the second exposure event 304, the third exposure event 306 and the fourth exposure event 308 to obtain a first weight parameter 310 (associated with the first exposure event 302), a second weight parameter 312 (associated with the second exposure event 304), a third weight parameter 314 (associated with the third exposure event 306) and a fourth weight parameter 316 (associated with the fourth exposure event 308).

How the coefficient is determined is not limited. In some no-limiting embodiments of the present technology, the coefficient is a pre-determined value assigned by an administrator of the crowd-sourcing application 118. In some non-limiting embodiments of the present technology, the coefficient is a different value depending on the first exposure event 302, the second exposure event 304, the third exposure event 306 and the fourth exposure event 308.

In some alternative non-limiting embodiments of the present technology, instead of calculating a weighted parameter for each of the first exposure event 302, the second exposure event 304, the third exposure event 306 and the fourth exposure event 308, a single weighted parameter may be calculated based on the set of exposure events 300 as a whole, or partly. For example, each instance of the first exposure event 302, the second exposure event 304, the third exposure event 306 and the fourth exposure event 308 may be assigned a predetermined score, and the single weighted parameter may correspond to a sum of the predetermined scores. Needless to say, it is further contemplated that the single parameter can be calculated based on one or more of the first exposure event 302, the second exposure event 304, the third exposure event 306 and the fourth exposure event 308 without having a predetermined score assigned, or in other words, be a single unweighted parameter.

Returning to FIG. 1, in some non-limiting embodiments of the present technology, the server 102 is further communicatively coupled to a preference database 126 via a dedicated link (not numbered). In alternative non-limiting embodiments of the present technology, the preference database 126 may be communicatively coupled to the server 102 via the communication network 110, without departing from the teachings of the present technology. Although the preference database 126 is illustrated schematically herein as single entity, it is contemplated that the preference database 126 may be configured in a distributed manner.

The preference database 126 is configured to collect and store information associated with the plurality of crowd-sourced workers 105. For example, the preference database 126 may store a preference parameter (not separately numbered) which is indicative of a given crowd-sourced worker's (such as the crowd-sourced worker 106) preferences. For example, the preference parameter might be generated based on the given crowd-sourced worker's preferred revenue range per task, preferred completion time per task, and preferred difficulty per task. How the preference parameter is generated for each of the crowd-sourced workers of the plurality of crowd-sourced workers 105 is not limited.

It is contemplated that the server 102 is configured to receive a set of results of the tasks that has been completed by the plurality of crowd-sourced workers 105 via a data packet 122 over the communication network 110, and in response to receiving the data packet 122, the crowd-sourcing application 118 is configured to analyze the results and generate, or update, the associated preference parameters.

Although the description of the system 100 has been made with reference to various hardware entities (such as the database 104, the server 102, the event database 124, the task database 121 and the like) depicted separately, it should be understood that this is done for ease of understanding. It is contemplated that the various functions executed by these various entities be executed by a single entity or be distributed among different entities.

### Crowd-Sourcing Application 118

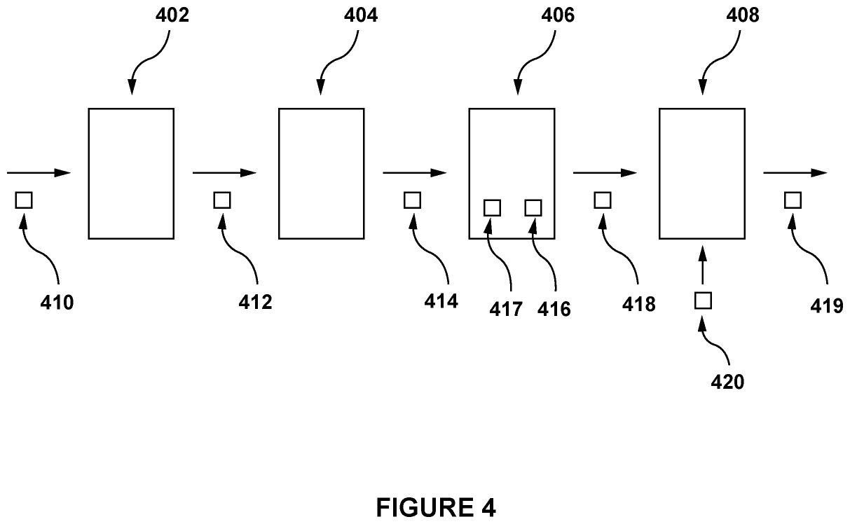

With reference to FIG. 4, there is depicted a schematic diagram of a process for presenting a digital task in a computer-implemented crowd-sourced environment. The process for presenting the digital task is executed by the crowd-sourcing application 118 (see FIG. 1) implemented in accordance with a non-limiting embodiment of the present technology. The crowd-sourcing application 118 executes (or otherwise has access to): a receiving routine 402, a determination routine 404, a ranking routine 406, and an output routine 408.

In the context of the present specification, the term “routine” refers to a subset of the computer executable program instructions of the crowd-sourcing application 118 that is executable by the server processor 116 (the receiving routine 402, the determination routine 404, the ranking routine 406, and the output routine 408). For the avoidance of any doubt, it should be expressly understood that the receiving routine 402, the determination routine 404, the ranking routine 406, and the output routine 4086 are illustrated herein as separate entities for ease of explanation of the processes executed by the crowd-sourcing application 118. It is contemplated that some or all of the receiving routine 402, the determination routine 404, the ranking routine 406, and the output routine 408 may be implemented as one or more combined routines.

For ease of understanding the present technology, functionality of each of the receiving routine 402, the determination routine 404, the ranking routine 406, and the output routine 408, as well as data and/or information processed or stored therein are described below.

### Receiving Routine 402

The receiving routine 402 is configured to receive a data packet 410. The data packet 410 is transmitted by the electronic device 120 associated with the crowd-sourced worker 106 (see FIG. 1). The data packet 410 comprises an indication that the crowd-sourced worker 106 desires to complete one or more digital tasks. For example, let us assume that the crowd-sourced worker 106 has indicated its preference to execute nudity recognition tasks.

In response to receiving the data packet 410, the receiving routine 402 is configured to access the task database 121 and retrieve the subset of tasks 204 (corresponding to the indicated preference).

The receiving routine 402 is then configured to transmit a data packet 412 to the determination routine 404. The data packet 412 comprises the subset of tasks 204.

### Determination Routine 404

In response to receiving the data packet 412, the determination routine 404 is configured to determine, for each task included within the subset of tasks 204, an exposure parameter. In some non-limiting embodiments of the present technology the exposure parameter is indicative of a level of exposure of each task included within the subset of tasks 204. In other words, the determination routine 404 is configured to determine how each task of the subset of tasks 204 has been exposed to the plurality of crowd-sourced workers 105 previously.

How the determination routine 404 is configured to determine the exposure parameter is not limited. In some non-limiting embodiments of the present technology, the determination routine 404 is configured to determine the exposure parameter based on the set of exposure events 300 (see FIG. 3).

Taking the first task 206 as an example, the determination routine 404 is configured to determine the exposure parameter based on the first weight parameter 310, the second weight parameter 312, the third weight parameter 314 and the fourth weight parameter 316.

In some non-limiting embodiments of the present technology, the exposure parameter corresponds to the sum of the first weight parameter 310, the second weight parameter 312, the third weight parameter 314 and the fourth weight parameter 316.

Alternatively, instead of the exposure parameter corresponding to the sum of the first weight parameter 310, the second weight parameter 312, the third weight parameter 314 and the fourth weight parameter 316, it is contemplated that the exposure parameter corresponds to the sum of only two or more of the first weight parameter 310, the second weight parameter 312, the third weight parameter 314 and the fourth weight parameter 316. For example, the exposure parameter may correspond to the sum of the first weight parameter 310 and the second weight parameter 312.

In yet another alternative non-limiting embodiment of the present technology, it is contemplated that instead of the exposure parameter being based on one or more of the weighted parameters (i.e. the first weight parameter 310, the second weight parameter 312, the third weight parameter 314 and the fourth weight parameter 316), the exposure parameter can be based on one or more of the unweighted first exposure event 302, the second exposure event 304, the third exposure event 306 and the fourth exposure event 308. For example, recalling that the first exposure event 302 corresponds to 10 (see FIG. 3), the exposure parameter may correspond to 10. In another example, recalling that the first exposure event 302 corresponds to 10 and the second exposure event 304 corresponds to 4 (see FIG. 3), the exposure parameter may correspond to 14.

In some alternative non-limiting embodiments of the present technology, where only a single parameter is calculated (as previously discussed), the single parameter is used as is as the exposure parameter.

Having determined the exposure parameter for each of the tasks included within the subset of tasks 204, the determination routine 404 is configured to transmit a data packet 414 to the ranking routine 406. The data packet 414 comprises the exposure parameter for each of the tasks included within the subset of tasks 204.

### Ranking Routine 406

In response to receiving the data packet 414, the ranking routine 406 is configured to execute the following functions.

Firstly, the ranking routine 406 is configured to generate a first ranked list using each of the tasks included within the subset of tasks 204. In some non-limiting embodiments of the present technology, the first ranked list comprises a randomly generated rank. In some alternative non-limiting embodiments of the present technology, the first ranked list is generated based on a task parameter, which includes one or more of (i) the estimated time of completion; (ii) the estimated difficulty; and (iii) the revenue of the subset of tasks 204. In some further alternative non-limiting embodiments, the first ranked list is generated based on the crowd-sourced worker's 106 most important preferred parameter, which may be determined by analyzing the preference parameter of the crowd-sourced worker 106 by accessing the preference database 126.

For example, assuming that the subset of tasks 204 comprises a total of 6 tasks and the crowd-sourced worker 106 has a higher preference for easy tasks, the ranking routine 406 is configured to rank the 6 tasks based on the difficulty of each task. Needless to say, it is contemplated that the subset of tasks 204 comprises more or fewer than 6 tasks.

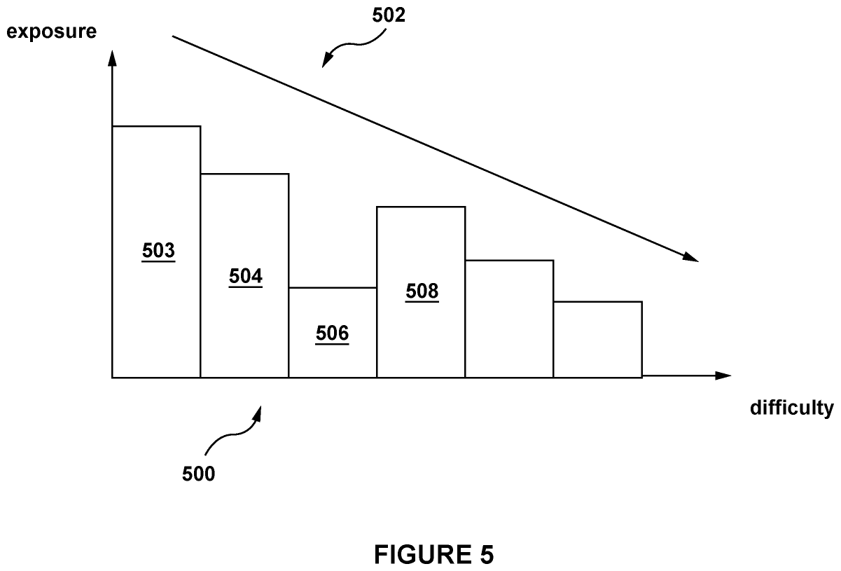

With reference to FIG. 5, there is illustrated a table illustrating an actual exposure parameters distribution 500, where the x-axis comprises the subset of tasks 204 arranged in order of the first ranked list (ex, in order of difficulty), and where the y-axis illustrates the exposure parameter of each of the 6 tasks.

In some non-limiting embodiments of the present technology, the ranking routine 406 is configured to identify one or more tasks not meeting a predetermined threshold.

In some non-limiting embodiments of the present technology, the predetermined threshold corresponds to a predetermined level of exposure. For example, the predetermined level of exposure may correspond to a desired level of exposure requested by the task requester when submitting the task to the task database 121 (such as, 10 exposure events within the past 24 hours, 5 completions within 5 hours and the like). In another example, the predetermined level of exposure may correspond to a desired past exposure events and a total exposure volume including past exposure events and desired future exposure events.

In some non-limiting embodiments of the present technology, the predetermined threshold corresponds to a normal distribution of exposure parameters 502 in a normally distributed subset of the tasks 204.

For example, the normal distribution of exposure parameters 502 corresponds to a line that is in an inversely proportional relationship between the x-axis (ex. Difficulty) and the exposure parameter (y-axis). More precisely, the normal distribution of exposure parameters 502 is highest in the y-axis when the difficulty is low, and linearly decreases as the difficulty is increased. Similarly, if the x-axis corresponds to the revenue, the normal exposure parameters 502 is highest in the y-axis when the revenue is highest, and linearly decreases as the revenue decreases.

The normal distribution of exposure parameters 502 is based on the assumption by the developers that the more the task is difficult (or alternatively, there is less revenue by the task), the corresponding exposure parameter should decrease, since fewer assessors would be interested to complete.

The ranking routine 406 is then configured to compare the actual exposure parameters distribution 500 and the normal distribution of exposure parameters 502 and identify one or more task that is abnormally placed in the actual exposure parameters distribution 500.

Taking the actual exposure parameters distribution 500, there is provided a first digital task 503, a second digital task 504, a third digital task 506 and a fourth digital task 508.

Based on the normal distribution of exposure parameters 502, the third digital task 506 is determined to be abnormally placed, since the fourth digital task 508 has a higher exposure parameter than the third digital task 506. In order words, despite a task parameter (i.e. difficulty) of the third digital task 506 being easier than the fourth digital task 508, the third digital task 506 is not receiving a comparatively higher exposure.

Returning to FIG. 4, in response to determining the third digital task 506 not meeting a pre-determined threshold (in the specific example to be abnormally placed within the first ranked list), the ranking routine 406 is configured to generate a second ranked list 416. In some non-limiting embodiments of the present technology, the second ranked list 416 has the third digital task 506 promoted, or in other words, the rank of the third digital task 506 is higher than in the first ranked list. In other words, the third digital task 506 ranked in third place within the first ranked list will be promoted to either the first place (before the first digital task 503) or the second place (between the first digital task 503 and the second digital task 504).

How the second ranked list 416 is generated is not limited. In some non-limiting embodiments of the present technology, the ranking routine 406 is configured to execute a machine learning algorithm (MLA) 417 configured to generate the second ranked list 416.

In other words, the MLA 417 is configured to determine a new position of the third digital task 506 based on the preference parameter retrieved from the preference database 126 that is associated with the crowd-sourced worker 106 and the third digital task 506. As such, the MLA 417 is trained to promote the rank of the third digital task 506 while optimizing one or both of the exposure parameter of the third digital task 506 and the crowd-sourced worker's 106 preference parameter. In other words, the MLA 417 is configured to maintain a balance between the promotion of the rank of the third digital task 506 and the crowd-sourced worker's 106 preference parameter.

As an example, let us assume that the preference parameter of the crowd-sourced worker 106 is indicative that the crowd-sourced worker 106 prefers tasks that can be done within 5 minutes, and the third digital task 506 has an estimated time of 4 minutes. Since the preference parameter is aligned with the third digital task 506, the MLA 417 may be configured to promote the third digital task 506 to the first position. Alternatively, if for example, the third digital task 506 has an estimated time of 10 minutes, the third digital task 506 may still be promoted by the MLA 417 but in the second position.

Having generated the second ranked list 416, the ranking routine 406 is then configured to transmit a data packet 418 to the output routine 408. The data packet 418 comprises the second ranked list 416.

### Output Routine 408

In response to receiving the data packet 414, the output routine 408 is configured to transmit the second ranked list 416, via a data packet 419. to the electronic device 120 that has previously transmitted the data packet 410.

In some non-limiting embodiments of the present technology, the subset of tasks 204 is displayed on the electronic device 120 in accordance with the second ranked list 416.

In some non-limiting embodiments of the present technology, after having transmitted the data packet 419, the output routine 408 is further configured to receive a data packet 420 from the electronic device 120. In some non-limiting embodiments of the present technology, the data packet 420 comprises one or more responses from the crowd-sourced worker 106 vis-a-vis the second ranked list 416.

For example, the data packet 420 may comprise information such as, but not limited to, which task within the subset of tasks 204 has been (i) displayed by the electronic device 120; (ii) hovered by the crowd-sourced worker 106; (iii) clicked by the crowd-sourced worker 106; and (iv) completed by the crowd-sourced worker 106. Needless to say, it is also contemplated that the data packet 420 further comprises the answers, or labels, submitted by the crowd-sourced worker 106.

In response to receiving the data packet 420, the output routine 408 is configured to access the event database 124 and update the set of exposure events 300 (see for example, FIG. 3) for each of the task within the subset of tasks 204. For example, assuming that the third digital task 506 has been clicked and completed, the output routine 408 is configured to update the set of exposure events of the third digital task 506 and calculate a new exposure parameter. Similarly, for uncompleted tasks which were exposed or hovered, the output routine 408 is configured to update the set of exposure events and calculate a new exposure parameter.

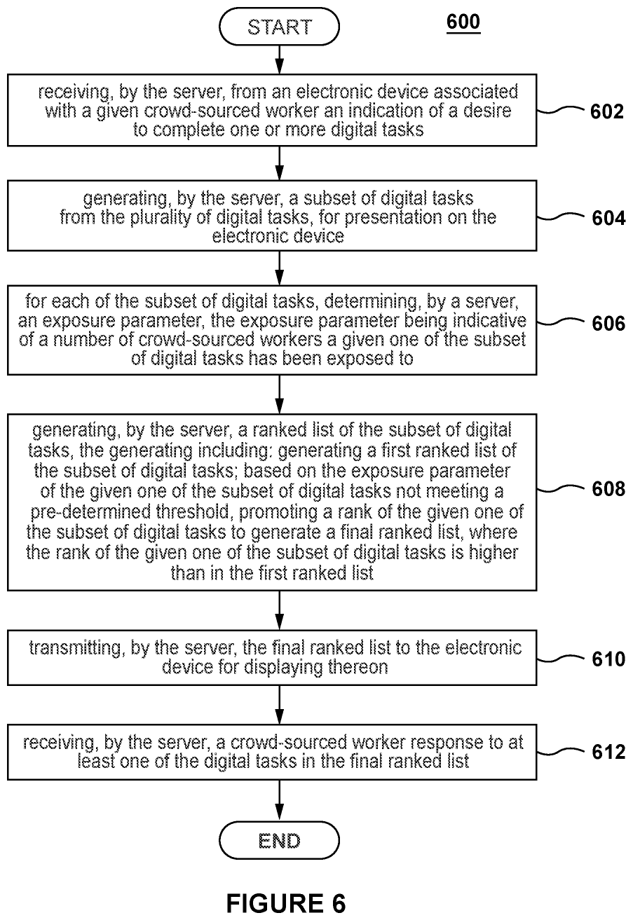

Given the architecture and examples provided hereinabove, it is possible to execute a computer-implemented method for presenting a task in a crowd-sourced environment. With reference to FIG. 6, there is depicted a flow chart of a method 600, the method 600 being executable in accordance with non-limiting embodiments of the present technology. The method 600 can be executed by the server 102.

Step 602: Receiving, by the Server, from an Electronic Device Associated with a Given Crowd-Sourced Worker an Indication of a Desire to Complete One or More Digital Tasks

The method 600 starts at step 602, where the receiving routine 402 receives the data packet 410. The data packet 410 is transmitted by the electronic device 120 associated with the crowd-sourced worker 106. The data packet 410 comprises an indication that the crowd-sourced worker 106 desires to complete one or more digital tasks. For example, let us assume that the crowd-sourced worker 106 has indicated its preference to execute nudity recognition tasks.

Step 604: Generating, by the Server, a Subset of Digital Tasks from the Plurality of Digital Tasks, for Presentation on the Electronic Device

At step 604, in response to receiving the data packet 410, the receiving routine 402 is configured to access the task database 121 and retrieve the subset of tasks 204.

Step 606: For Each of the Subset of Digital Tasks, Determining, by a Server, an Exposure Parameter, the Exposure Parameter being Indicative of a Number of Crowd-Sourced Workers a Given One of the Subset of Digital Tasks has been Exposed to

At step 606, in response to receiving the data packet 412, the determination routine 404 is configured to determine, for each tasks included within the subset of tasks 204, an exposure parameter. In some non-limiting embodiments of the present technology the exposure parameter is indicative of a level of exposure of each task included within the subset of tasks 204. In other words, the determination routine 404 is configured to determine how each task of the subset of tasks 204 has been exposed to the plurality of crowd-sourced workers 105 previously.

How the determination routine 404 is configured to determine the exposure parameter is not limited. In some non-limiting embodiments of the present technology, the determination routine 404 is configured to determine the exposure parameter based on the set of exposure events 300 (see FIG. 3).

Step 608: Generating, by the Server, a Ranked List of the Subset of Digital Tasks, the Generating Including: Generating a First Ranked List of the Subset of Digital Tasks; Based on the Exposure Parameter of the Given One of the Subset of Digital Tasks not Meeting a Pre-Determined Threshold, Promoting a Rank of the Given One of the Subset of Digital Tasks to Generate a Final Ranked List, where the Rank of the Given One of the Subset of Digital Tasks is Higher than in the First Ranked List

the ranking routine 406 is configured to generate a first ranked list using each of the tasks included within the subset of tasks 204. In some non-limiting embodiments of the present technology, the first ranked list comprises a randomly generated rank. In some non-limiting embodiments of the present technology, the first ranked list is generated based on one of (i) the estimated time of completion; (ii) the estimated difficulty; and (iii) the revenue of the subset of tasks 204. In some non-limiting embodiments, the first ranked list is generated based on the crowd-sourced worker's 106 most important preference, which may be determined by analyzing the preference parameter of the crowd-sourced worker 106 by accessing the preference database 126.

For example, assuming that the subset of tasks 204 comprises a total of 6 tasks and the crowd-sourced worker 106 has a higher preference for easy task, the ranking routine 406 is configured to rank the 6 tasks based on the difficulty of each task. Needless to say, it is contemplated that the subset of tasks 204 comprises more or less than 6 tasks.

In some non-limiting embodiments of the present technology, the ranking routine 406 is configured to identify one or more task not meeting a predetermined threshold. In some non-limiting embodiments of the present technology, the predetermined threshold corresponds to a normal distribution of exposure parameters 502 in a normally distributed subset of the tasks 204.

For example, the normal distribution of exposure parameters 502 corresponds to a line that is in inversely proportional relationship between the difficulty (x-axis) and the exposure parameter (y-axis). More precisely, the normal distribution of exposure parameters 502 is highest in the y-axis when the difficulty is low, and linearly decreases as the difficulty is increased.

The normal distribution of exposure parameters 502 is based on the assumption by the developers that the more the task is being difficult (or alternatively, there is less revenue by task), the corresponding exposure parameter should decrease.

The ranking routine 406 is then configured to compare the actual exposure parameters distribution 500 and the normal distribution of exposure parameters 502 and identify one or more task that is abnormally placed in the actual exposure parameters distribution 500.

Based on the normal distribution of exposure parameters 502, the third digital task 506 is determined to be abnormally placed, since the fourth digital task 508 has a higher exposure parameter than the third digital task 506. In order words, despite the difficulty of the third digital task 506 being easier than the fourth digital task 508, the third digital task 506 is not receiving a comparatively higher exposure.

In response to determining the third digital task 506 to be abnormally placed within the first ranked list, the ranking routine 406 is configured to generate a second ranked list 416. In some non-limiting embodiments of the present technology, the second ranked list 416 has the third digital task 506 promoted, or in other words, the rank of the third digital task 506 is higher than in the first ranked list.

Having generated the second ranked list 416, the ranking routine 406 is then configured to transmit a data packet 418 to the output routine 408. The data packet 418 comprises the second ranked list 416.

### Step 610: Transmitting, by the Server, the Final Ranked List to the Electronic Device for Displaying Thereon

At step 610, the output routine 408 is configured to transmit the data packet 419 to the electronic device 120 which has previously transmitted the data packet 410. The data packet 419 comprises the second ranked list 416.

### Step 612: Receiving, by the Server, a Crowd-Sourced Worker Response to at Least One of the Digital Tasks in the Final Ranked List

At step 612, the output routine 408 is configured to receive, from the electronic device 120, the data packet 420. In some non-limiting embodiments of the present technology, the data packet 420 comprises one or more responses from the crowd-sourced worker 106 vis-a-vis the second ranked list 416.

For example, the data packet 420 may comprise information such as, but not limited to, which task within the subset of tasks 204 has been (i) displayed by the electronic device 120; (ii) hovered by the crowd-sourced worker 106; (iii) clicked by the crowd-sourced worker 106; and (iv) completed by the crowd-sourced worker 106.

In response to receiving the data packet 420, the output routine 408 is then configured to update the set of exposure events (see for example, FIG. 3) for each of the task within the subset of tasks 204.

The method 600 then terminates.

It should be apparent to those skilled in the art that at least some embodiments of the present technology aim to expand a range of technical solutions for addressing a particular technical problem encountered by the conventional crowd-sourced technology, namely providing a task within the crowd-sourced environment.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or reordered without departing from the teachings of the present technology. Accordingly, the order and grouping of the steps is not a limitation of the present technology.

1. A computer-implemented method for presenting a digital task in a computer-implemented crowd-sourced environment, the computer implemented environment being associated with a plurality of digital tasks to be executed by one or more of a plurality of crowd-sourced workers, the plurality of digital tasks including the digital task, the method being executed by a server, the method comprising:
receiving, by the server, from an electronic device associated with a given crowd-sourced worker an indication of a desire to complete one or more digital tasks;
generating, by the server, a subset of digital tasks from the plurality of digital tasks, for presentation on the electronic device;
for each of the subset of digital tasks, determining, by a server, an exposure parameter, the exposure parameter being indicative of a number of crowd-sourced workers a given one of the subset of digital tasks has been exposed to;
generating, by the server, a ranked list of the subset of digital tasks, the generating including:
generating a first ranked list of the subset of digital tasks;
based on the exposure parameter of the given one of the subset of digital tasks not meeting a pre-determined threshold, promoting a rank of the given one of the subset of digital tasks to generate a final ranked list, where the rank of the given one of the subset of digital tasks is higher than in the first ranked list;
transmitting, by the server, the final ranked list to the electronic device for displaying thereon;
receiving, by the server, a crowd-sourced worker response to at least one of the digital tasks in the final ranked list.

2. The method of claim 1, wherein the generating the subset of digital tasks comprises receiving, by the server, a filter request from the electronic device, and wherein the generating the subset of digital tasks comprises selecting the subset of digital tasks based on the filter request.

3. The method of claim 1, wherein the exposure parameter is based on a pre-determined exposure event.

4. The method of claim 3, wherein the pre-determined exposure event is at least one of: a screen-showing event to any one of the plurality of crowd-sourced workers, a click event, and a task completion event.

5. The method of claim 4, further comprising updating the exposure parameter for the given one of the subset of digital tasks based on the crowd-sourced worker response.

6. The method of claim 5, further comprising updating the exposure parameter for other digital tasks of the subset of digital tasks based on the crowd-sourced worker response.

7. The method of claim 4, wherein the exposure parameter is based on two or more pre-determined exposure events.

8. The method of claim 7, wherein the two or more pre-determined exposure events are weighted.

9. The method of claim 1, wherein the pre-determined threshold is a normal distribution of exposure parameters in a normally distributed subset of the plurality of digital tasks.

10. The method of claim 9, wherein the method further comprises generating an actual exposure parameters distribution of the subset of the plurality of digital tasks and the normally distributed subset of the plurality of digital tasks, and wherein the exposure parameter not meeting the threshold comprises the exposure parameter of the given task is being abnormally placed in the actual exposure parameters distribution of the subset of the plurality of digital tasks.

11. The method of claim 10, wherein being abnormally placed is indicative of abnormal exposure parameters of the given one of the subset of digital tasks given one or more task parameters of the given one of the subset of digital tasks.

12. The method of claim 1, wherein the pre-determined threshold is a value indicative of desired past exposure events and a total exposure volume including past exposure events and desired future exposure events.

13. The method of claim 1, wherein the promoting the rank of the given one of the subset of digital tasks is further based on a crowd-sourced worker preference parameter.

14. The method of claim 13, wherein the promoting is based on optimizing one or both of the exposure parameter and the crowd-sourced worker preference parameter.

15. The method of claim 14, wherein the optimizing is executed by a Machine Learning Algorithm (MLA).

16. The method of claim 1, wherein the generating the first ranked list comprises generating randomly generated ranks.

17. The method of claim 1, wherein the generating the first ranked list comprises generating a rank based on preferences of the given crowd-sourced worker.

18. A system for presenting a digital task in a computer-implemented crowd-sourced environment, the computer implemented environment being associated with a plurality of digital tasks to be executed by one or more of a plurality of crowd-sourced workers, the plurality of digital tasks including the digital task, the system comprising a server, the server comprising a processor configured to:
receive from an electronic device associated with a given crowd-sourced worker an indication of a desire to complete one or more digital tasks;
generate a subset of digital tasks from the plurality of digital tasks, for presentation on the electronic device;
for each of the subset of digital tasks, determine, an exposure parameter, the exposure parameter being indicative of a number of crowd-sourced workers a given one of the subset of digital tasks has been exposed to;
generate, a ranked list of the subset of digital tasks, the generating including:
generating a first ranked list of the subset of digital tasks;
based on the exposure parameter of the given one of the subset of digital tasks not meeting a pre-determined threshold, promoting a rank of the given one of the subset of digital tasks to generate a final ranked list, where the rank of the given one of the subset of digital tasks is higher than in the first ranked list;
transmit, the final ranked list to the electronic device for displaying thereon;
receive, a crowd-sourced worker response to at least one of the digital tasks in the final ranked list.

19. The system of claim 18, wherein to generate the subset of digital tasks, the processor is configured to receive a filter request from the electronic device, and wherein the generating the subset of digital tasks comprises selecting the subset of digital tasks based on the filter request.

20. The system of claim 18, wherein the exposure parameter is based on a pre-determined exposure event.
